(19) United States
(12) Patent Application Publication
(10) Pub. No.: US 2018/0371266 A1
(43) Pub. Date: Dec. 27, 2018

(54) POLYMERIC ANTI-SKINNING AND DRIER COMPOUNDS

(71) Applicant: EGE KIMYA SAN. VE TIC. A. S., Istanbul (TR)

(72) Inventor: Eddy CLAUWAERT, Brugges (BE)

(73) Assignee: EGE KIMYA SANAYI VE TICARET A. S., Istanbul (TR)

(21) Appl. No.: 16/062,573

(22) PCT Filed: Nov. 30, 2016
(86) PCT No.: PCT/TR2016/050473

§ 371 Date: Jun. 14, 2018

(30) Foreign Application Priority Data
Dec. 15, 2015 (TR) 2015/16126

(51) Int. Cl. C09D 7/46; C09D 7/48

(52) U.S. Cl. CPC C09D 7/46; C08G 18/348; C09D 7/48

(57) ABSTRACT

The present disclosure relates to polymer compounds for use as both a drying agent and an anti-skinning agent in coatings and paints. In one embodiment, a polymer compound comprises a urethanized polymer having a metal, an antioxidant, and a water solubility according to OECD 105 below 20 mg/l. Methods of synthesizing and using such polymer compounds are also disclosed.

### TECHNICAL FIELD

The present disclosure relates to polymers, and in particular to polymers used in coatings, paints, or inks as drying agents and anti-skinning agents.

### BACKGROUND

As the drying rate of uncatalyzed air-drying systems, such as alkyd paints, is too slow for commercial applications, it is common practice to accelerate the drying process by adding metal driers (also known as drying agents) to the system. Without driers, a typical alkyd paint may take as long as days, if not weeks to dry, which is clearly undesirable for most applications.

Primary driers catalyze the formation and/or decomposition of peroxides, which are formed by the reaction of oxygen with the air-drying binder or drying oil. Metal carboxylates, and in particular cobalt carboxylates, have hitherto been the principal constituents of driers, at least if drying has to take place at room temperature and within a reasonable time. The use of cobalt carboxylates, and in particular of cobalt octoates have been widely described, and is common practice throughout the paint industry (e.g., see J. H. Bieleman, in Additives for Coatings, ED. J. H. Bieleman, Wiley NCH, Weinheim, 2000, p. 202).

Nevertheless cobalt has shown carcinogenic effects on in vivo inhalation tests. It is generally assumed that this toxicity is related to the cobalt ion, as the tested compounds had relatively high water solubility and generated appreciable cobalt ion concentrations. The available data for most of the standard cobalt carboxylates is such that serious concern about their carcinogenicity is justified, which makes their future use as driers in auto-oxidative paint and ink systems problematic.

Whereas the cobalt carboxylate is a primary drier, other transition metals such as manganese also fulfill a role in this process. The effect of manganese carboxylates is most noticeable at higher temperatures, or else at room temperature when used as an auxiliary drier with cobalt. The higher temperatures needed for the development of the catalytic activity of manganese as a primary drier are around 80° C., conditions normally found on printing presses. Hence, manganese driers can be used in these applications.

Although manganese is an essential component of life, e.g., as the central atom in Super Oxide Dismutase (SOD'S), there is a known toxicology on manganese compounds as well. Manganese carboxylates have not been classified as yet, but it has been demonstrated that manganese carboxylates release manganese ions in aqueous solutions. Concern about the future classification of manganese carboxylates is therefore justified.

It is known that the application of printing inks on fast running rotary printing presses causes the formation of an airborne aerosol of fine ink droplets around the printing press. As the primary risk to workers is therefore absorption through inhalation, it is important to lower the water solubility, and hence the release of metal ions at the pH values typically found in lung fluids, which is around neutral.

As noted above, metal carboxylates are used in a broad range of applications, with special importance in the paint and varnish industry, where they are used as driers and rheological modifiers, as accelerators for unsaturated polyesters, as lubricating oil additives, as biocides, and more.

Thus, although metal carboxylates have had a wide range of uses and applications, the introduction of stricter regulations for chemicals in general has made the future uncertain, and in particular for certain metal carboxylates, such as for the cobalt and manganese compounds, where unacceptable toxic profiles are suspected.

It has been found that the toxicity of these compounds is related to the water solubility. High water solubility, together with subsequent hydrolysis, gives elevated concentrations of the metal ions in aqueous media. It has to be remembered that this higher metal ion concentration will occur in biological fluids which in turn will increase the probability of toxic effects.

It is possible to reduce the water solubility, and additionally the resulting metal ion concentration, by including the metal atom into a polymeric structure. The increased molecular weight with the more complex molecular structure reduces the water solubility of the compounds so that the threshold values for toxicity are not attained.

However, prior polymer compounds with reduced water solubility of toxic metal ion concentrations had several technical problems and disadvantages. A first technical problem and disadvantage was a limitation on the metal content that could be obtained while still having usable viscosity levels. For example, prior metal content for cobalt and manganese was typically below 6% by weight, thereby placing a limitation on the catalytic, drying, modifier, and/or accelerator function of the polymer compound. A second disadvantage was a limitation on the viscosity of the polymer compound solution, which was typically high compared to classical products, thereby limiting the choice of solvent for the product to very strong solvents, such as glycol derivatives, which themselves are substances of concern due to their toxicological properties.

Vegetable oil based coating systems with alkyd resins have been investigated for mitigating or solving problems associated with water-based/emulsion-based systems including but not limited to: difficulty in obtaining a high gloss, a high proportion of volatile organic compounds (VOCs), use of biocides, a high carbon footprint, and contamination of domestic wastewater systems.

However, vegetable oil based systems have also needed two separate types of additives with unfavorable toxicological properties to properly function. One additive has been the aforementioned drier agent and another additive, as further described below, has been an anti-skinning agent.

Whereas the drying of an emulsion-based paint is based on the coagulation of polymer droplets, and the associated absorption and evaporation of the carrier (combination of water and co-solvents), the drying of oil-based paints and varnishes is based on a chemical reaction, together with the evaporation of the volatile components.

The chemical reaction is initiated by the absorption of oxygen by the paint carrier like the alkyd resin. This oxygen forms peroxides and hydroperoxides with the unsaturated fatty acid chains in the alkyd resin. These oxidized products are unstable and decompose according to a free radical mechanism, which results in a polymerization of the binder molecules and the formation of a dry film.

An alkyd paint or varnish with a primary drier, or a combination of primary and secondary driers, will polymerize when brought into contact with air. As a paint can or container typically has a space above the paint, and paint must be usable even after repeated openings of the container, the resulting air ingress will start the above-described dry film process, and a film will start to form on the surface of the paint. This is known as “skinning” in the related art, and a “skinned” paint must be filtered to remove the “skin”. Thus, skinning causes a problem for a user of the skinned paint or varnish, which requires the user to remove the skin (preferably without spillage or user contact) before using the paint or varnish.

To mitigate skinning, industry has investigated the use of anti-skinning agents as an additive to paints and coatings. Previously, anti-skinning agents have been mainly oxime-type products, such as methyl ethyl ketoxime (also methyl ethyl ketone oxime) (MEKO). Unfortunately, as with the drier agents, the regulations on chemicals as described in the REACH project (EU), requesting thorough examination of every chemical used in consumer products, shows a very unfavorable toxicological profile for such oxime-type products. As these oximes are volatile substances and must evaporate from the film to start the drying process, the user will often be exposed to the oximes through inhalation of the evaporated material. Attempts have been made to replace methyl ethyl ketoximes with other products, especially by higher molecular weight oximes, but these have been no more than partial solutions at best.

Thus, industry has previously used separate drying and anti-skinning agents with both types of agents having toxic or hazardous effects for the user and/or environment. Accordingly, there is still a need in the art for drier and anti-skinning agents for use in coatings, paints, or inks, that are more user-safe and environmentally-friendly while maintaining their effectiveness as drier and anti-skinning agents.

### BRIEF DESCRIPTION OF THE INVENTION

The present invention provides for a new class of metal-bearing and antioxidant-bearing urethanized polymer compound, which allows for both the catalytic effects of the metal towards the oxidative drying of polymers and the anti-skinning effects of the antioxidant component in a single polymer compound. The urethanized polymer compound also has low water solubility to advantageously reduce the possibility of worker exposure to metals. In one example, the polymer compound is soluble in a “green” and low-VOC solvent. For example, the solvent may be bioderived, biodegradable, and have a low VOC content. Thus, the urethanized polymer compound of the present invention greatly avoids toxic effects by eliminating the use of oximes, reducing the availability of the metal ions in aqueous systems, and being soluble in a “green” (e.g., biodegradable) and low-VOC solvent, while providing for both anti-skinning and drying functionality in a single compound.

In accordance with one embodiment disclosed herein, a polymer compound for use as both a drying agent and an anti-skinning agent in coatings, paints, or inks is described. The polymer compound comprises a metal-bearing and antioxidant-bearing urethanized polymer having a metal, an antioxidant, and a water solubility according to OECD 105 below 20 mg/l, in one embodiment.

In accordance with another embodiment, a polymer compound is comprised of a metal-bearing and antioxidant-bearing urethanized polymer having the following formula (I):

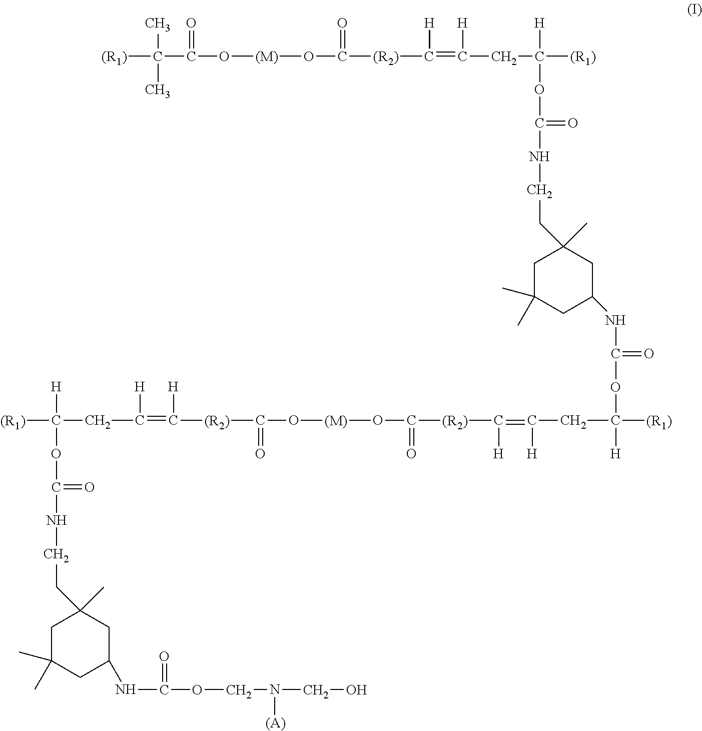

wherein M is a metal, A is an antioxidant group, R₁ is an alkyl group, and R₂ is an alkyl group. In one example, metal M is selected from the group consisting of cobalt, manganese, cerium, and iron; R₁ is an alkyl group with 6 carbon atoms; and/or R₂ is an alkyl group with 7 carbon atoms.

In accordance with one example, the antioxidant group A may have the following formula (II):

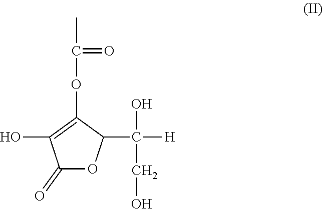

In accordance with yet another embodiment, a metal-bearing and antioxidant-bearing urethanized polymer as described herein is dissolved in a low-VOC solvent, wherein the low-VOC solvent is at least one member from the group consisting of lactate esters (e.g., ethyl lactate, methyl lactate, or another ester of lactic acid with an alcohol) and fatty acid esters (e.g., butyl linoleate), and any combination thereof.

Another embodiment disclosed herein pertains to a series of coating, paint and ink compositions comprising the polymer compound as described herein as a curing catalyst. In one embodiment, a composition includes a urethanized polymer as described herein mixed with an unsaturated fatty acid modified polymer-based binder.

Also described herein is a process for preparing the polymer compounds of the present disclosure. In one embodiment, a process for preparing a polymer compound includes providing a carboxylic acid, reacting the carboxylic acid with a metal hydroxide or metal acetate to form an intermediate product, and mixing the intermediate product with a solvent (e.g., a lactate ester solvent) to form a first mixture. The preparation process further includes providing a coupling agent (e.g., an amine coupling agent) to the first mixture to form a second mixture, providing an antioxidant (e.g., including at least one of citric acid, ethyl ascorbic acid, ascorbic acid, resveratrol, or any combinations thereof) to the second mixture to form a third mixture, and polymerizing the third mixture with an isocyanate to form a metal-bearing and antioxidant-bearing urethanized polymer. In one example, the urethanized polymer is formed to have a metal, an antioxidant, and a water solubility according to OECD 105 below 20 mg/l.

In a further example, the urethanized polymer may be formed: to have a metal content greater than 6% by weight; to have a metal content between 4% and 8% by weight; such that the metal is an integral part of a backbone of the polymer compound; wherein the metal is selected from the group consisting of cobalt, manganese, cerium, and iron; wherein the carboxylic acid is provided as a hydroxyl carboxylic acid or a saturated fatty acid; wherein the carboxylic acid is ricinoleic acid, the metal hydroxide is cobalt hydroxide or manganese hydroxide, the coupling agent is an alkanol amine, and the isocyanate is toluene diisocyanate, isophorone diisocyanate (IPDI), or hexamethylene di-isocyanate (HMDI); wherein the coupling agent is provided as an amine selected from the group consisting of a monohydroxyl amine, a dihydroxyl amine, a trihydroxyl amine, and a combination thereof; wherein the urethanized polymer is formed to have a viscosity less than 3000 cP at 20° C.; wherein the urethanized polymer is formed to have a mean molecular weight less than 2000 Da; or any applicable combination of the aforementioned attributes of the urethanized polymer. It is further noted that the various components of the polymer compound described above can be alternatives which may be combined in various applicable and functioning combinations within the scope of the present invention.

Further described herein is a process for curing a polymer-based coating composition. In one embodiment, a method of curing a polymer-based coating composition includes providing a polymer compound as described herein, mixing the polymer compound with an unsaturated fatty acid modified polymer-based binder, and then drying a coating of the mixture of the polymer compound and the binder.

Yet another embodiment pertains to the use of the polymer compounds as described herein as a curing catalyst for hardening of unsaturated polyesters.

Advantageously, the polymer compounds and processes for preparing the polymer compounds as disclosed herein have resulted in a drier and anti-skinning agent compound for use in coatings, paints, or inks, that is more environmentally-friendly and user-safe. The use of oximes has been eliminated, and instead, antioxidants have been incorporated into a metal-bearing and antioxidant-bearing polymeric structure, thus eliminating toxic components while allowing for solubility in low-VOC solvents and maintaining effectiveness as both a drier and anti-skinning agent.

### BRIEF DESCRIPTION OF THE DRAWINGS

These and other features, aspects, and advantages of the present invention will become better understood when the following detailed description is read with reference to the accompanying drawings in which like characters represent like parts throughout the drawings. Unless noted, the drawings may not be drawn to scale.

FIG. 1 illustrates a general structure of the class of metal-bearing and antioxidant-bearing urethanized polymer compounds in accordance with an embodiment as described in the present disclosure.

FIG. 2 illustrates an example antioxidant group in accordance with an embodiment as described in the present disclosure.

FIG. 3 is a flowchart of a method of preparing the polymer compounds in accordance with an embodiment as described in the present disclosure.

FIG. 4 is another flowchart of a method of preparing the polymer compounds in accordance with an embodiment as described in the present disclosure.

### DETAILED DESCRIPTION

Compounds

The present invention pertains to a series of metal-bearing and antioxidant-bearing polymer compounds (both metal and antioxidant components in a single compound) for use as simultaneous drier and anti-skinning agents in coatings, paints, or inks. The present invention also pertains to drier and anti-skinning compositions comprised of the polymer compound dissolved in a low-VOC solvent, and also pertains to a coating composition comprised of the polymer compound combined with a binder. The present invention further pertains to methods for preparing the polymer compounds. It is noted that the polymer compounds of the present invention may also function as an accelerator or have various other functions in coatings, paints, or inks.

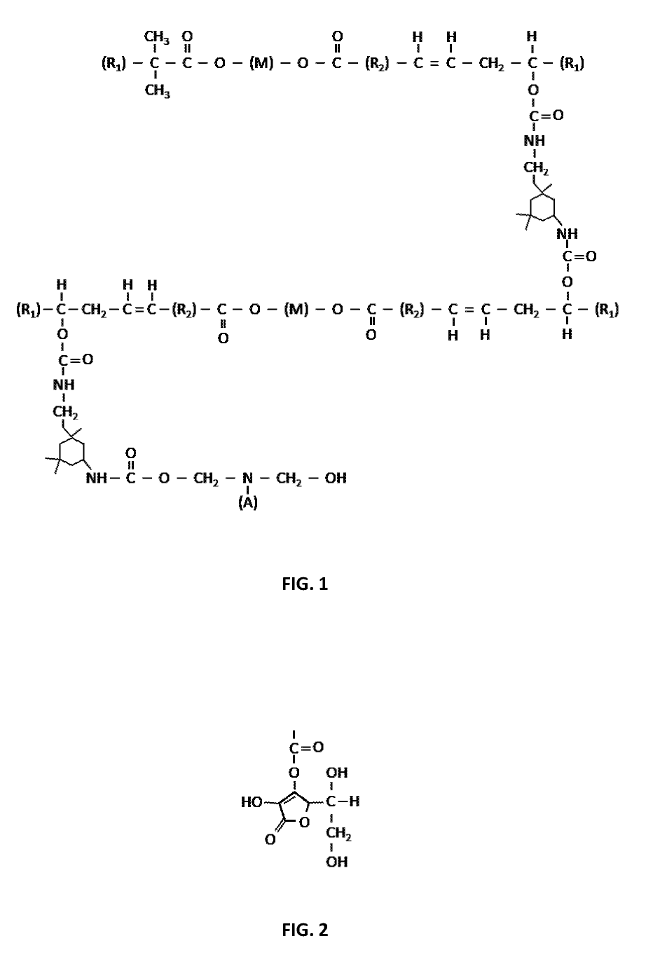

Referring now to FIG. 1, a general structure of the class of metal-bearing and antioxidant-bearing polymer compounds is shown in accordance with an embodiment as described in the present disclosure. In one embodiment, the polymer compounds are characterized by including a metal-bearing and antioxidant-bearing urethanized polymer having the following formula (I) below and also as shown in FIG. 1:

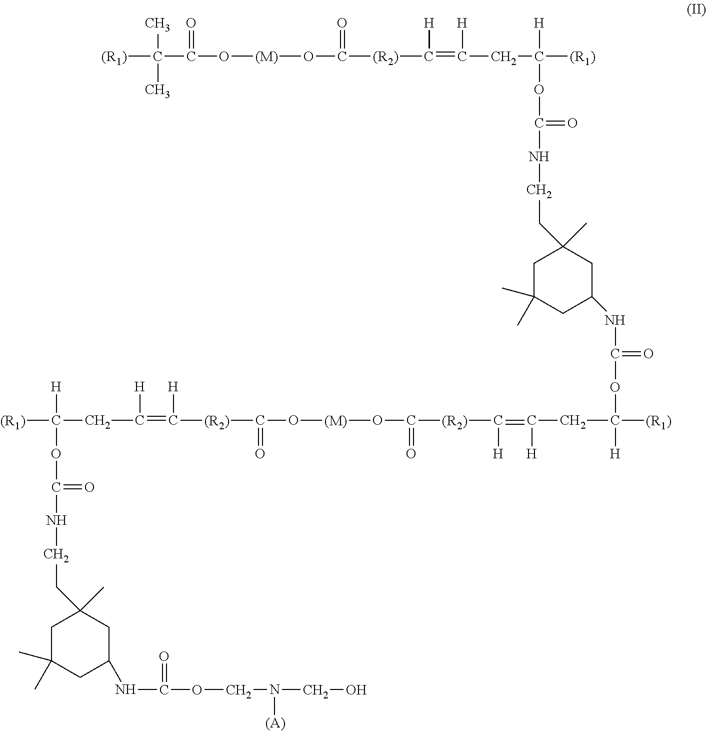

wherein M is a metal, A is an antioxidant group, R1 is a first alkyl group, and R2 is a second alkyl group.

In one example, the metal M may include one of cobalt, manganese, cerium, and iron. In one example, the alkyl group R₁ may include an alkyl group of 6 carbon atoms (e.g., C₆H₁₃). In one example, the alkyl group R₂ may include an alkyl group of 7 carbon atoms (e.g., C₇H₁₄).

In accordance with one example, the antioxidant group A may have the following formula (II) below and also as shown in FIG. 2:

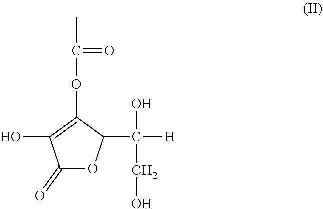

In a further example, the antioxidant group A may be formed from reacting citric acid, ethyl ascorbic acid, resveratrol, ascorbic acid, or any combination thereof.

It has been demonstrated that a urethanized polymer compound with formula (I) as shown in FIG. 1 has a reduced toxicity risk by using a polyurethane structure—hence introducing nitrogen into the molecule—on a reacted carboxylic acid and antioxidant to advantageously provide both a metal and an antioxidant within the polymeric structure.

In accordance with the scope of the present invention, the urethanized polymer compound of formula (I) may: have a water solubility according to OECD 105 below 20 mg/l; have a viscosity less than 3000 cP at 20° C.; have a mean molecular weight less than 2000 Da; have a metal content greater than 6% by weight; have a metal content between 4% and 8% by weight; be soluble in a low-VOC solvent, wherein the low-VOC solvent is an ester solvent selected from the group consisting of a lactate ester and a fatty acid ester; and any applicable combinations thereof.

Furthermore, the urethanized polymer compound of formula (I) may be formed at least in part from a carboxylic acid, a metal hydroxide or metal acetate, a coupling agent, an antioxidant, and an isocyanate. The coupling agent may be an amine selected from the group consisting of a monohydroxyl amine, a dihydroxyl amine, a trihydroxyl amine, and any combination thereof. The antioxidant may be an antioxidant mixture including ascorbic acid, ethyl ascorbic acid, resveratrol, citric acid, and any combination thereof. The carboxylic acid may be a hydroxyl carboxylic acid or a saturated fatty acid. In one example, the carboxylic acid is ricinoleic acid, the metal hydroxide is cobalt hydroxide or manganese hydroxide, the coupling agent is an alkanol amine, the antioxidant mixture includes ascorbic acid, ethyl ascorbic acid, and resveratrol, and the isocyanate is toluene diisocyanate, isophorone diisocyanate (IPDI), or hexamethylene di-isocyanate (HMDI).

In accordance with an embodiment as described herein, an advantageous polymer compound for use as both a drying agent and an anti-skinning agent in coatings, paints, or inks is disclosed. The polymer compound comprises a metal-bearing and antioxidant-bearing urethanized polymer having a metal, an antioxidant, and a water solubility according to OECD 105 below 20 mg/l.

In accordance with an embodiment as described herein, the urethanized polymer may have a metal content greater than 6% by weight; a metal content between 4% and 8% by weight; the metal may be an integral part of a backbone of the polymer compound; the metal may be selected from the group consisting of cobalt, manganese, cerium, and iron; or any applicable combinations of the aforementioned descriptions of the metal.

In accordance with an embodiment as described herein, the urethanized polymer is soluble in a “green” and low-VOC solvent. The low-VOC solvent may include an ester solvent selected from the group consisting of a lactate ester, a fatty acid ester, and combinations thereof.

In accordance with an embodiment as described herein, the urethanized polymer is formed at least in part from a carboxylic acid, a metal hydroxide or metal acetate, a coupling agent, an antioxidant, and an isocyanate.

In accordance with an embodiment, the carboxylic acid may be a hydroxyl carboxylic acid or a saturated fatty acid, or combinations thereof.

In accordance with an embodiment, the coupling agent may be an amine. In one example, the coupling agent may be an alkanol amine selected from the group consisting of a monohydroxyl amine, a dihydroxyl amine, a trihydroxyl amine, or a combination thereof. It is noted that a combination of alkanolamines may be used for obtaining desired properties such as for viscosity, solubility, etc. It is further noted that the coupling agent amine includes a hydroxyl function for reacting with the isocyanate.

In accordance with an embodiment, the antioxidant may be formed from an antioxidant mixture including one of ascorbic acid (0%-100% by weight), ethyl ascorbic acid (0%-100% by weight), resveratrol (0%-100% by weight), citric acid (0%-100% by weight), or any applicable combinations thereof. For instance, the antioxidant may be formed from an antioxidant mixture of ascorbic acid, ethyl ascorbic acid, and resveratrol.

In accordance with another embodiment as described herein, the carboxylic acid is ricinoleic acid, the metal hydroxide is cobalt hydroxide or manganese hydroxide, the coupling agent is an alkanol amine, the antioxidant mixture includes ascorbic acid, ethyl ascorbic acid, and resveratrol, and the isocyanate is toluene diisocyanate, isophorone diisocyanate (IPDI), or hexamethylene di-isocyanate (HMDI).

Furthermore, in accordance with an example as described herein, the urethanized polymer has a viscosity less than 3000 cP at 20° C. In yet another example, the urethanized polymer has a mean molecular weight less than 2000 Da.

It is noted that a polymer compound “for use as a polymerization agent” has to be at least partially soluble in the targeted coatings, paints and inks, which are typically based on organic compounds, in particular on oils such as vegetable oils. The mean molecular weight can be estimated from the remaining free functionalities of the polymer and or the polymer synthesis sequences, or by an appropriate analytical technique, such as gel permeation chromatography (GPC). Fatty acids are the preferred carboxylic acids, as such alkyd type polymers are more compatible with the alkyd binders used in paints and inks. The polymer compound may be unsaturated to increase its solubility in unsaturated binders for paints or inks, and to participate in the drying process not only as a catalyst. According to one embodiment, the polymer compound is completely soluble in printing ink media such as hydrocarbon or alkyd resins, or any mixture thereof.

The metal atoms in the polymer compounds as described herein, for example, cobalt, manganese, cerium, or iron atoms, are preferably an integral part of the backbone of the polymer. In other words, the metal atoms form bonds in the backbone chain of polymers. Such bound metal imparts its full catalytic effect to the polymer, while its water solubility is greatly suppressed. In one embodiment, the urethanized backbone is aliphatic or aromatic. Furthermore, the polymer compounds described in the present disclosure are typically unsaturated, although saturated forms are also possible. The unsaturated forms have the advantage of copolymerizing with the main binder in the system resulting in an even lower water solubility of the dried paint which is an advantage on the toxicological side.

The polymer compounds and process for preparing the polymer compounds as disclosed herein have resulted in numerous advantages over the state of the art. An embodiment of the present invention provides a drier and anti-skinning compound for use in coatings, paints, or inks, that is more environmentally-friendly and user-safe while maintaining its effectiveness as both a drier and anti-skinning agent. The urethanized polymer compound of the present invention greatly avoids toxic effects by eliminating the use of oximes, reducing the availability of the metal ions in aqueous systems, and being soluble in a low-VOC solvent.

Furthermore, the polymer compounds as disclosed herein have resulted in a drier and anti-skinning compound that solves compatibility issues with coatings, paints, or inks. Mixing or blending antioxidant into a paint formulation can cause compatibility issues as resins are typically hydrophilic in nature. However, the present invention advantageously incorporates an antioxidant into a polymer compound and thus allows for antioxidant compatibility with a paint or coating formulation of interest.

In addition, as the antioxidant group is fixedly positioned close to the metal on the polymer (instead of being randomly mixed or blended into a paint formulation), the chemical activity and effectiveness of the antioxidant group is enhanced. Otherwise, one would have to add higher concentrations of antioxidant for the same anti-skinning effect if antioxidant was simply blended into a paint formulation, and such higher concentrations of antioxidant could cause slower drying times.

In addition to drier and anti-skinning functionality, the polymer compounds and process for preparing the polymer compounds as disclosed herein have resulted in a narrower molecular weight distribution in the polymer compound, thereby providing for polymer compounds with better solubility and hence lower viscosity in the same solvent, allowing for easier dispersion in a coating, paint or ink system. Furthermore, the choice of suitable solvents has become much larger than previously possible, such that environmentally-friendly solvents can now be used.

Since the urethanized polymer compound of the present invention provides for both anti-skinning and drying functionality in a single compound, improved efficiencies, ease of use, and ease of production are achieved.

It is further disclosed that the new compounds as described herein may be made (e.g., in the case of cobalt and manganese) at a metal content greater than 6% w/w (weight percentage) for improved efficacy of the polymer compound. Moreover, the solvent, instead of a glycol derivative like hexylene glycol which has been previously required, can now be replaced by a low-VOC solvent, like ethyl lactate, which is advantageously bioderived, biodegradable, and has a low-VOC content. As the maximum concentration of VOC solvent in alkyd paints is limited, this is a considerable advantage for the alkyd paint formulator.

As previous products were formulated using a combination of dimer acids and monomeric fatty acids as main starting materials, the previous polymeric substances had very broad molecular weight distributions. Polymerization was obtained through balancing the proportions of dimer acids and fatty acids, followed by esterification or urethanisation. Dimer acids are in themselves a complex mixture of monomeric fatty acids, real dimer acids, trimer acids and even some high molecular weight compounds. Starting from such complex materials disadvantageously resulted in a broad spectrum of molecules, where especially the high molecular weight components have a negative effect on viscosity, solubility, and compatibility, and the low molecular weight components in the mixture have a negative effect on water solubility.

Advantageously, the polymer compounds as described in the present disclosure are formed from mixtures of carboxylic acids and/or hydroxycarboxylic acids, reacted with a metal hydroxide or metal acetate, reacted with an antioxidant, and then further reacted with an isocyanate, thereby eliminating oximes while incorporating antioxidants into a polymeric drier structure, thus eliminating toxic components while allowing for solubility in “green” and low-VOC solvents. After urethanisation the obtained mixtures may have: (1) a very low content of low molecular weight species; and (2) the desired low water solubility without high amounts of high molecular weight fractions. It is noted that the various components that make up the polymer compound or the various components that describe the polymer compound disclosed above can be alternatives which may be combined in various applicable and functioning combinations within the scope of the present invention.

Compositions

Another embodiment as described in the present disclosure pertains to a series of coating, paint and ink compositions comprising a polymer compound as described herein and used as a curing catalyst. In one embodiment, a coating composition comprises a binder mixed with a polymer compound as described herein. In one embodiment, a binder polymer is selected from the group consisting of alkyd polymers and alkyd-oil combinations.

A further embodiment concerns coating formulations wherein a urethanized polymer compound as described herein is used as the sole drier in a paint or ink system. In one example of a cobalt-bearing or a manganese-bearing urethanized polymer compound, the resulting metal concentration in a ready-to-use paint or ink is typically in the range of 0.05% to 0.1%, calculated on the weight of the auto-oxidative binder in the system.

In a further embodiment of compositions, a composition may include a first metal-bearing urethanized polymer compound and can optionally include a second metal-bearing compound, with the first metal and the second metal being different metals. In one example, the first metal may be manganese and the second metal may be cobalt. The cobalt-bearing compound may include a cobalt carboxylate or a polymeric cobalt carboxylate. The binder preferably comprises an unsaturated fatty acid modified polymer. The polymer compound may be adapted so as to co-polymerize with this binder.

According to one embodiment, compositions are advantageously prepared as solutions in a low-VOC solvent or a mix of various low-VOC solvents. The solvent(s) for instance can be one or more from the group consisting of lactate esters (e.g., ethyl lactate, methyl lactate, or another ester of lactic acid with an alcohol) and fatty acid esters (e.g., butyl linoleate), or combinations thereof.

Metal-bearing and antioxidant-bearing urethanized polymer compounds as described herein are also applicable to composites for use as curing agents in unsaturated polyesters. Advantageously, compounds as described herein provide efficient and homogenous dispersion in unsaturated polyester based matrices of composites and provide efficient curing thereof. Differently than in coating, paint and ink applications where the oxygen from the ambient serves as an initiator, a peroxide initiator is needed for composites applications to initiate the curing.

General Synthesis Process

One embodiment as described in the present disclosure pertains to processes for preparing the polymer compounds as described herein. In accordance with one embodiment, a process for preparing a polymer compound includes providing a carboxylic acid, reacting the carboxylic acid with a metal hydroxide or metal acetate to form an intermediate product, and mixing the intermediate product with a solvent (e.g., a lactate ester) to form a first mixture. The preparation process further includes providing an amine coupling agent to the first mixture to form a second mixture, providing an antioxidant including at least one of citric acid, ethyl ascorbic acid, ascorbic acid, resveratrol, or combinations thereof, to the second mixture to form a third mixture, and polymerizing the third mixture with a polyfunctional isocyanate to form a metal-bearing and antioxidant-bearing urethanized polymer. In one example, the urethanized polymer is formed to have a metal, an antioxidant, and a water solubility according to OECD 105 below 20 mg/l. Advantageously, metal ions and antioxidants are reacted with isocyanates in one embodiment, thus allowing for both drier and anti-skinning functionality in the same compound. The urethanized polymer may be formed within the scope of the present invention to have other attributes as described herein in various combinations.

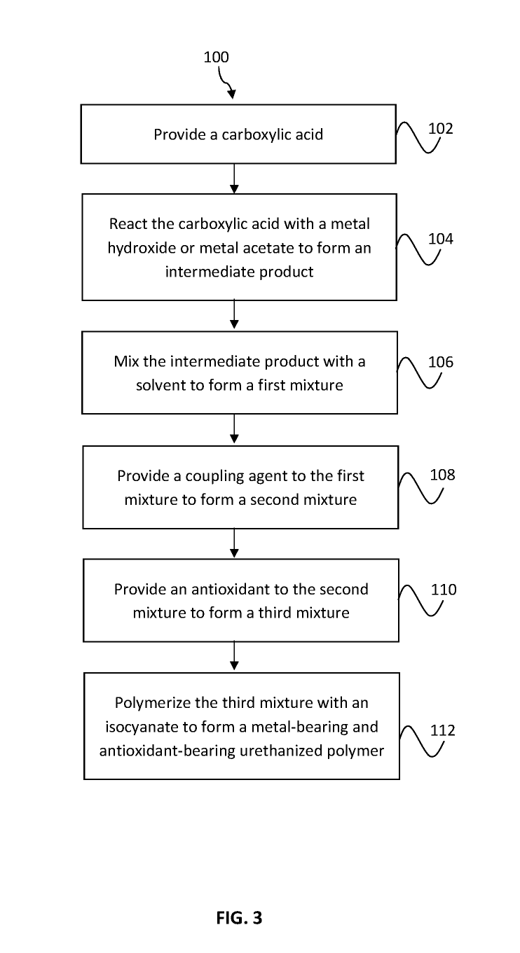

Referring now to FIG. 3, a flowchart of a method 100 is shown for preparing the polymer compounds in accordance with an embodiment as described in the present disclosure. Method 100 includes providing a carboxylic acid at step 102, and reacting the carboxylic acid with a metal hydroxide or metal acetate to form an intermediate product at step 104. Method 100 further includes mixing the intermediate product with a solvent to form a first mixture at step 106, providing a coupling agent to the first mixture to form a second mixture at step 108, providing an antioxidant to the second mixture to form a third mixture at step 110, and polymerizing the third mixture with an isocyanate to form a metal-bearing urethanized polymer having an antioxidant at step 112.

In accordance with an embodiment, the carboxylic acid may be provided at step 102 as a hydroxyl carboxylic acid or a saturated fatty acid.

In accordance with an embodiment, the urethanized polymer may be formed to have a metal content greater than 6% by weight or between 4% and 8% by weight. The urethanized polymer may also be formed such that the metal is an integral part of a backbone of the polymer compound.

In one embodiment, a metal-bearing raw material at step 104 is cobalt hydroxide or a manganese salt or oxide, such as manganese (II) acetate tetrahydrate in one example. In other embodiments, this reaction scheme is applicable to a multivalent metal that can be obtained in a reactive form. Metals such as cerium (Ce) and iron (Fe) can also be used besides cobalt (Co) and manganese (Mn).

In accordance with an embodiment, the carboxylic acid may be ricinoleic acid, the metal hydroxide may be cobalt hydroxide or manganese hydroxide, the coupling agent may be an alkanol amine, and the isocyanate may be toluene diisocyanate, isophorone diisocyanate (IPDI), or hexamethylene di-isocyanate (HMDI).

In accordance with an embodiment, method 100 may comprise dissolving the urethanized polymer in a low-VOC solvent (e.g., at step 106, after step 112, and/or at various steps 102 through 112), wherein the low-VOC solvent is at least one member from the group consisting of lactate esters (e.g., ethyl lactate, methyl lactate, or another ester of lactic acid with an alcohol), fatty acid esters (e.g., butyl linoleate), or combinations thereof. It is noted that the urethanized polymer may be diluted with a solvent to have a suitable viscosity as desired, but in one example the urethanized polymer has a viscosity less than 3000 cP at 20° C.

In accordance with an embodiment, the coupling agent may be provided at step 108 as an amine selected from the group consisting of a monohydroxyl amine, a dihydroxyl amine, a trihydroxyl amine, and a combination thereof.

In accordance with an embodiment, the antioxidant may be provided at step 110 as an antioxidant including at least one of citric acid, ethyl ascorbic acid, ascorbic acid, resveratrol, or combinations thereof, for mixing with the second mixture to form a third mixture. Thus, an antioxidant mixture may include one of ascorbic acid (0%-100% by weight), ethyl ascorbic acid (0%-100% by weight), resveratrol (0%-100% by weight), citric acid (0%-100% by weight), or any applicable and functioning combinations thereof.

The polymerization at step 112 is carried out with an isocyanate (e.g., a polyfunctional isocyanate), commonly a bi-functional isocyanate, and in one example is isophorone di-isocyante (IPDA). Other suitable isocyanates include but are not limited to toluene di-isocyanate (TDI), hexamethylene di-isocyanate (HMDI), and the like. Mixtures of di- and mono-isocyanates (e.g., methylene isocyanate) can also be used to control the average molecular weight.

In accordance with an embodiment, the urethanized polymer may be formed to have a water solubility according to OECD 105 below 20 mg/l, advantageously providing for reduced metal exposure levels for the user.

The composition can also be modified by adding non-metal bearing polymers as diluents. Solvents can be left in, removed or changed over to adjust the final viscosity of the ready-to-use product.

To be usable for the purposes as described, the final product is soluble in the majority of the polymers that are used in the manufacture of coatings, paints and inks.

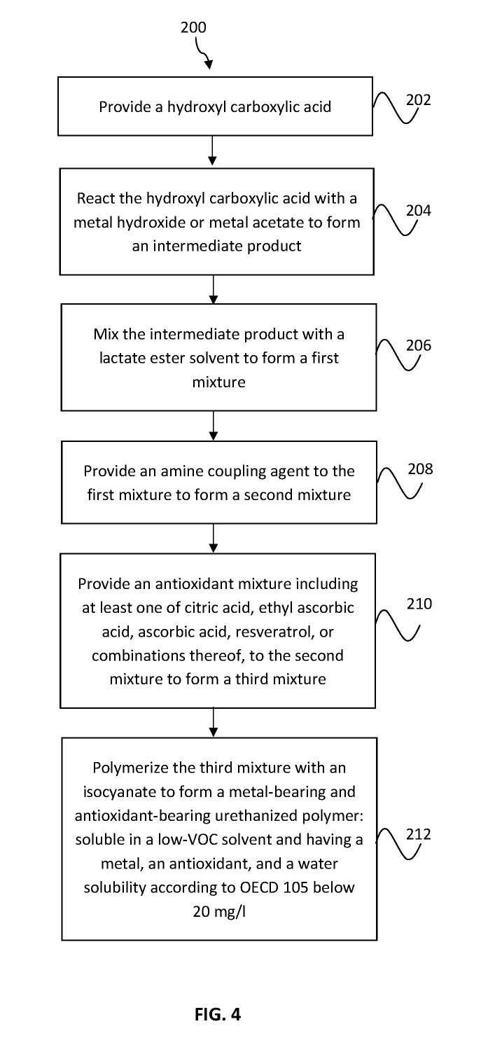

Referring now to FIG. 4, a flowchart of a method 200 is shown for preparing the polymer compounds in accordance with another embodiment as described in the present disclosure. Method 200 includes providing a hydroxyl carboxylic acid at step 202, and reacting the hydroxyl carboxylic acid with a metal hydroxide or metal acetate to form an intermediate product at step 204. Method 200 further includes mixing the intermediate product with a lactate ester solvent to form a first mixture at step 206, and providing an amine coupling agent to the first mixture to form a second mixture at step 208. Method 200 further includes providing an antioxidant mixture including at least one of citric acid, ethyl ascorbic acid, ascorbic acid, resveratrol, or combinations thereof, to the second mixture to form a third mixture at step 210. Method 200 further includes polymerizing the third mixture with an isocyanate to form a metal-bearing and antioxidant-bearing urethanized polymer soluble in a low-VOC solvent and having a metal, an antioxidant, and a water solubility according to OECD 105 below 20 mg/l.

There are several methods known to determine the molecular weight of these kinds of compounds. A primary method used is the normal Gel Permeation Chromatography (GPC) method. Analyses were performed on a polystyrene column, with samples diluted in tetrahydrofurane. Polystyrene standards were used for calibration, and afterwards the method was checked on normal vegetable oils and bodied oils for verification. Prior to injection, samples may be decomposed and molecular weights calculated back to the original substance.

### Synthesis Examples of Metal-Bearing Polymer Compounds Including an Antioxidant

### Example 1

311 grams of ricinoleic acid (RA) was added to a cylindrical reaction flask or reactor, with heating and cooling capability, equipped with a heated high torque stirrer, and under nitrogen blanket. The flask was heated to 130° C.

At 130° C., 50 grams of cobalt hydroxide was fed gradually to the reactor until the temperature reached 150° C. When the addition of cobalt hydroxide was complete, the reactor was set to 160° C. and stirred for one hour under vacuum to form an intermediate compound.

50 grams of anhydrous (water content below 0.1%) ethyl lactate (EL) was added to the reactor and heating was switched off. When the temperature reached 110° C., 40 grams of anhydrous EL was added to the reactor. When the temperature dropped to 100° C., 50 grams of diethanolamine (DEA) was added to the reactor as a coupling agent.

When the mixture cooled down to 90° C., an antioxidant mixture was added to the reactor. 20 grams of ethylascorbic acid, 15 grams of ascorbic acid (AA), and 4 grams of resveratrol was made into a slurry in 85 grams of anhydrous EL and was gradually added to the reactor. 55 grams of anhydrous EL was then added to the reactor.

15 grams of isophorone di-isocyanate (IPDI) was added to the reactor at a temperature of 90° C. The mixture was stirred for a half hour to react the IPDI, and then 100 grams of EL was added to the reactor. The homogeneous mixture was cooled down to room temperature and the reactor emptied.

The resulting product was a stable purple liquid, that was analyzed for cobalt content and adjusted to 4% cobalt content (w/w) with EL.

A sample was treated under high vacuum to remove solvent. The resulting product was tested for water solubility according to OECD 105. A value of 11 mg Co/I was found after 24 hours stirring at 20° C.

### Example 2

In the same equipment and under the same conditions as described under Example 1, the same initial reactions and mixtures were made with RA, cobalt hydroxide, and anhydrous EL, in the same proportions and temperature settings.

311 grams of ricinoleic acid (RA) was added to a cylindrical reaction flask or reactor, with heating and cooling capability, equipped with a heated high torque stirrer, and under nitrogen blanket. The flask was heated to 130° C.

At 130° C., 50 grams of cobalt hydroxide was fed gradually to the reactor until the temperature reached 150° C. When the addition of cobalt hydroxide was complete, the reactor was set to 160° C. and stirred for one hour under vacuum to form an intermediate compound.

50 grams of anhydrous (water content below 0.1%) ethyl lactate (EL) was added to the reactor and heating was switched off. When the temperature reached 110° C., 40 grams of anhydrous EL was added to the reactor. Similarly, when the temperature dropped to 100° C., 50 grams of DEA was added to the reactor as a coupling agent.

When the mixture cooled down to 90° C., a different antioxidant mixture was added to the reactor. 10 grams of ethylascorbic acid, 25 grams of AA, and 4 grams of resveratrol were made into a slurry in 85 grams of anhydrous EL and added to the reaction mix. 55 grams of anhydrous EL was then added to the reactor.

After complete reaction the product was urethanized in the same way as described under Example 1 using IPDI in the same proportions and temperature settings. 15 grams of IPDI was added to the reactor at a temperature of 90° C. The mixture was stirred for a half hour to react the IPDI, and then 100 grams of EL was added to the reactor. The homogeneous mixture was cooled down to room temperature and the reactor emptied. The product was finished by adding EL until the cobalt content was 4% (w/w).

A sample of this product was treated under high vacuum to remove solvent, and the resulting product was tested for water solubility according to OECD 105. A value of 14 mg Co/I was found after 24 hours stirring at 20° C.

### Example 3

350 grams of castor oil were added to a 1 liter glass reaction vessel or reactor, equipped with a stirrer, inert gas (N₂), and heating facility. 50 grams of DEA were added, and the temperature then raised to 90° C. Then a slurry of 20 grams of ethylascorbic acid, 15 grams of AA, and 4 grams of resveratrol in 85 grams of anhydrous ethyl lactate were added to the reactor, and stirred at 90° C. until complete reaction.

The product mixture was then urethanised with 15 grams of IPDI at 90° C. until negative for isocyanate as controlled by FTIR. The mixture was then further diluted with EL to a solids content of 70% w/w. The product was a clear yellowish liquid.

Anti-Skinning Test Results

Tests on anti-skinning activity were conducted as follows. Commercial production high gloss paint samples were obtained where no driers or anti-skinning agents had been added. A clear alkyd varnish, white paint, red paint, blue paint and black paint were used. Resin solids of the clear varnish was 62%, and resin solids for the pigmented paint samples was about 40%.

To all these systems, a cobalt-bearing agent was added to a concentration of 0.05% Co on resin solids. This was done with standard cobalt octoate (no anti-skinning added) (Control 1), with standard cobalt octoate but with 0.15% methyl ethyl ketoxime (MEKO) added (Control 2), with Example 1 as drier/anti-skinning agent, with Example 2 as drier/anti-skinning agent, and with Example 2 modified with 0.3 grams of Example 3 per 100 grams of finished product as drier/anti-skinning agent.

From every preparation, three (3) 100 ml wide necked glass flasks were filled as follows: one filled to 50% to be opened every two weeks, one filled to 95% to be opened every two weeks, and one filled to 95% to be kept closed. All flasks were upturned once to ensure a complete seal. All these samples were stored together at 20° C.

For testing, flasks were upturned regularly, as skin can easily be seen. Skinning normally stops the flow of the product. The flasks filled at 50%, and one of the flasks filled at 95% were opened once every two weeks, to simulate practical use circumstances. The second sample flask filled at 95% was never opened. Results from varnish formulations are summarized in Table 1 below.

TABLE 1

| | Flask filled | | Flask filled | | |
|---|---|---|---|---|---|
| | 50% | | 95% | | Flask filled |
| Drier/Anti- | (opened every | | (opened every | | 95% |
| Skinning Agent | two weeks) | | two weeks) | | (kept closed) |
| Control 1 | Overnight | | Overnight | | Overnight |
| (Cobalt Octoate) | skinning | | skinning | | skinning |
| Control 2 | 12 | weeks | 16 | weeks | 1 year skin-free |
| (Cobalt Octoate + | | | | | |
| MEKO) | | | | | |
| Example 1 | 10 | weeks | 14 | weeks | 1 year skin-free |
| Example 2 | 6 | weeks | 8 | weeks | 1 year skin-free |
| Example 2 + | 20 | weeks | 36 | weeks | 1 year skin-free |
| Example 3 | | | | | |

All the samples with the cobalt octoate (Control 1) skinned heavily overnight, indicating that the used system is representative. Furthermore, the examples of the present invention provided anti-skinning functionality which was comparable or improved relative to the traditional oxime product used as Control 2. For the flask samples filled to 50% and opened once every two weeks, skinning occurred in 12 weeks with Control 2 agent, skinning occurred in 10 weeks with Example 1 agent, skinning occurred in 6 weeks with Example 2 agent, and skinning occurred in 20 weeks with Example 2+Example 3 agent. For the flask samples filled to 95% and opened once every two weeks, skinning occurred in 16 weeks with Control 2 agent, skinning occurred in 14 weeks with Example 1 agent, skinning occurred in 8 weeks with Example 2 agent, and skinning occurred in 36 weeks with Example 2+Example 3 agent. For the flask samples filled to 95% and never opened, skinning did not occur for more than one year for all samples.

Drying Test Results

Drying time were measured on varnishes made with a commercial sunflower long oil alkyd, obtained at 70% solids content in aliphatic solvent. The resin was first diluted to 60% with Exxsol D 60 for application viscosity. The drier was added to obtain a cobalt content of 0.05% cobalt calculated on resin solids.

Agents used were standard cobalt octoate with 0.15% methyl ethyl ketoxime (MEKO) (Control 2) added to the varnish, Example 1, Example 2, and Example 2+Example 3.

Wet films of 75μ thickness were applied to glass plates and drying time recorded on a Beck Koller drying time recorder. Results are summarized in Table 2 below.

TABLE 2

| Drier/Anti-Skinning Agent | Touch Dry | Through Dry | |
|---|---|---|---|
| Control 2 | 2 hours | 6 | hours |
| (Cobalt Octoate + MEKO) | | | |
| Example 1 | 3 hours 30 minutes | 7 | hours |
| Example 2 | 3 hours 50 minutes | 7 | hours |
| Example 2 + Example 3 | 5 hours 20 minutes | 16 | hours |

For the sample with cobalt octoate and MEKO agent, the coating was touch dry in about 2 hours and through dry in about 6 hours. For the sample with the Example 1 agent, the coating was touch dry in about 3 hours 30 minutes and through dry in about 7 hours. For the sample with the Example 2 agent, the coating was touch dry in about 3 hours 50 minutes and through dry in about 7 hours. For the sample with the Example 2 modified with Example 3 agent, the coating was touch dry in about 5 hours 20 minutes and through dry in about 16 hours.

The tests show that it is possible with the examples of the present invention to obtain a correct combination of drying times, with avoidance of the skinning problem, and should be applicable to most oil alkyds. The new compounds and products as disclosed herein are not present in the vapor phase, and therefore the working principle is completely different from the oxime-type products previously used, which had to evaporate in order for drying to take place, thus resulting in likely user exposure to toxic vapor. It is possible to adapt the present invention products to a wide variety of working conditions typical for the paint industry.

Use of Compounds

An embodiment as described in the present disclosure pertains to the use of the polymer compounds as described herein as catalysts for drying of coatings, paints and inks based on unsaturated polymers.

In one embodiment, the polymer compounds as disclosed herein may be mixed with an unsaturated fatty acid modified polymer-based binder, and a coating of the mixture of the polymer compound and the binder may be dried.

Another embodiment pertains to use of the cobalt-bearing polymer compounds as described herein as curing catalysts for hardening of unsaturated polyesters.

Advantageously, the present invention provides for a new class of metal-bearing and antioxidant-bearing urethanized polymer compound, which allows for both the catalytic effects of the metal towards the oxidative drying of polymers and the anti-skinning effects of the antioxidant component. The urethanized polymer compound is also soluble in a low-VOC solvent. Thus, the urethanized polymer compound of the present invention greatly avoids toxic effects by eliminating the use of oximes, reducing the availability of the metal ions in aqueous systems, and being soluble in a low-VOC solvent, while providing for both anti-skinning and drying functionality in a single compound that can be used as an additive.

The foregoing examples have been provided merely for the purpose of explanation and are in no way to be construed as limiting of the present invention. While the present invention has been disclosed with reference to exemplary embodiments, the words used herein are intended to be words of description and illustration, rather than words of limitation. While the present invention has been described with reference to particular materials and embodiments, the present invention is not intended to be limited to the particulars disclosed herein. For example, the various components that make up the polymer compound disclosed above, or the various components that describe the polymer compound disclosed above, or the various method steps disclosed above, can be alternatives which may be combined in various applicable and functioning combinations within the scope of the present invention. Rather, the present invention extends to all functionally equivalent structures, materials, and uses, such as are within the scope of the appended claims. Changes may be made, within the purview of the appended claims, as presently stated and as may be amended, without departing from the scope and spirit of the present invention. All terms used in this disclosure should be interpreted in the broadest possible manner consistent with the context.

1-45. (canceled)

46. A polymer compound for use as both a drying agent and an anti-skinning agent in coatings, paints, or inks, the polymer compound comprising a urethanized polymer having a metal, an antioxidant, and a water solubility according to OECD 105 below 20 mg/l.

47. The polymer compound according to claim 46, wherein the urethanized polymer has a metal content greater than 6% by weight.

48. The polymer compound according to claim 46, wherein the urethanized polymer has a metal content between 4% and 8% by weight.

49. The polymer compound according to claim 46, wherein the metal is an integral part of a backbone of the polymer compound.

50. The polymer compound according to claim 46, wherein the metal is selected from the group consisting of cobalt, manganese, cerium, and iron.

51. The polymer compound according to claim 46, wherein the urethanized polymer is soluble in a low-volatile organic compound (low-VOC) solvent.

52. The polymer compound according to claim 46, wherein the urethanized polymer is formed at least in part from a carboxylic acid, a metal hydroxide or metal acetate, a coupling agent, an antioxidant mixture, and an isocyanate.

53. The polymer compound according to claim 46, wherein the urethanized polymer has a viscosity less than 3000 cP at 20° C.

54. The polymer compound according to claim 46, wherein the urethanized polymer has a mean molecular weight less than 2000 Da.

55. A polymer compound for use as both a drying agent and an anti-skinning agent in coatings, paints, or inks, the polymer compound comprising a metal-bearing and antioxidant-bearing urethanized polymer having the following formula: 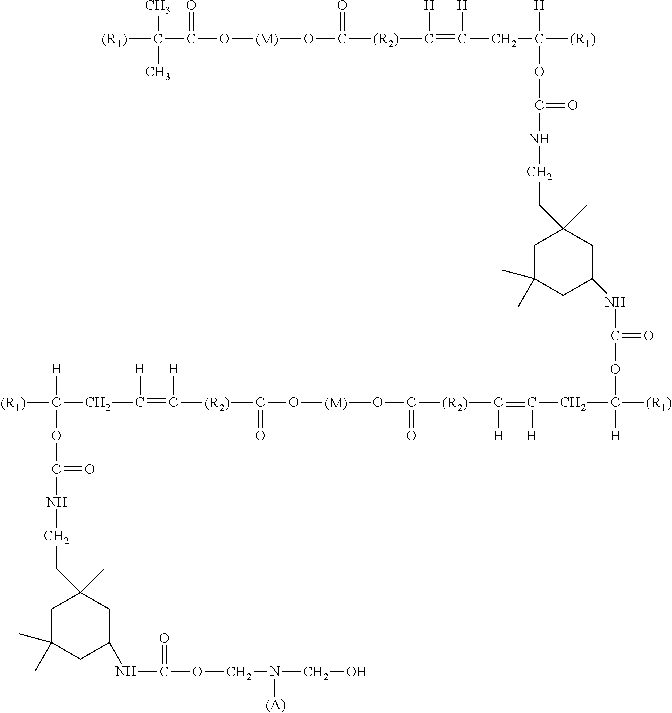
wherein
M is a metal;
A is an antioxidant group;
R₁ is a first alkyl group; and
R₂ is a second alkyl group.

56. The polymer compound according to claim 55, wherein the antioxidant group A has the following formula:

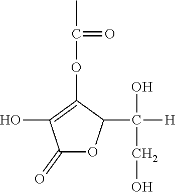

57. The polymer compound according to claim 55, wherein the metal M is selected from the group consisting of cobalt, manganese, cerium, and iron, wherein the alkyl group R₁ has 6 carbon atoms, and wherein the alkyl group R₂ has 7 carbon atoms.

58. The polymer compound according to claim 55, wherein the urethanized polymer has a metal content greater than 6% by weight.

59. The polymer compound according to claim 55, wherein the urethanized polymer has a metal content between 4% and 8% by weight.

60. The polymer compound according to claim 55, wherein the urethanized polymer is soluble in a low-volatile organic compound (low-VOC) solvent.

61. The polymer compound according to claim 55, wherein the urethanized polymer has a viscosity less than 3000 cP at 20° C.

62. The polymer compound according to claim 55, wherein the urethanized polymer has a mean molecular weight less than 2000 Da.

63. A drier and anti-skinning composition, comprising the polymer compound according to claim 46 dissolved in a low-VOC solvent, wherein the low-VOC solvent is at least one member from the group consisting of a lactate ester, a fatty acid ester, and any combination thereof.

64. A process for preparing a polymer compound, the process comprising:
providing a carboxylic acid;
reacting the carboxylic acid with a metal hydroxide or metal acetate to form an intermediate product;
mixing the intermediate product with a solvent to form a first mixture;
providing a coupling agent to the first mixture to form a second mixture;
providing an antioxidant including at least one of citric acid, ethyl ascorbic acid, ascorbic acid, resveratrol, or combinations thereof, to the second mixture to form a third mixture; and
polymerizing the third mixture with an isocyanate to form a urethanized polymer having a metal, an antioxidant, and a water solubility according to OECD 105 below 20 mg/l.

65. The process according to claim 63, wherein the urethanized polymer is formed to have a metal content greater than 6% by weight.

66. The process according to claim 63, wherein the urethanized polymer is formed to have a metal content between 4% and 8% by weight.

67. The process according to claim 63, wherein the metal is selected from the group consisting of cobalt, manganese, cerium, and iron.

68. The process according to claim 64, wherein the urethanized polymer is formed to have a viscosity less than 3000 cP at 20° C.

69. The process according to claim 64, wherein the urethanized polymer is formed to have a mean molecular weight less than 2000 Da.
